(19) United States
(12) Patent Application Publication
(10) Pub. No.: US 2015/0304625 A1
(43) Pub. Date: Oct. 22, 2015

(54) IMAGE PROCESSING DEVICE, METHOD, AND RECORDING MEDIUM

(71) Applicant: Sharp Kabushiki Kaisha, Osaka-shi, Osaka (JP)

(72) Inventors: Mikio SETO, Osaka-shi (JP); Hisao HATTORI, Osaka-shi (JP); Ikuko TSUBAKI, Osaka-shi (JP); Hisao KUMAI, Osaka-shi (JP)

(21) Appl. No.: 14/408,604

(22) PCT Filed: Jun. 17, 2013
(86) PCT No.: PCT/JP2013/066552

§ 371 Date: Dec. 17, 2014

(30) Foreign Application Priority Data
Jun. 19, 2012 (JP) 2012-138063

(51) Int. Cl. H04N 13/00; G06F 3/041; H04N 13/04

(52) U.S. Cl. CPC H04N 13/0022; H04N 13/0402; G06F 3/041; H04N 13/0422; H04N 2213/005

(57) ABSTRACT

An image processing device includes a viewing environmental light information acquirer and a sense-of-depth parameter adjustment amount calculator to adjust a sense-of-depth parameter (i.e., a parameter related to binocular cues and/or monocular cues) according to environmental light in a viewing environment. The viewing environmental light information acquirer is configured to acquire viewing environmental light information that is information related to environmental light in a viewing environment of a display device. The sense-of-depth parameter adjustment amount calculator is configured to calculate an adjustment amount of a sense-of-depth parameter of monocular cues and/or binocular cues used when the display device displays an image represented by image data based on the viewing environmental light information and image auxiliary data.

### BACKGROUND OF THE INVENTION

1. Field of the Invention

The present invention relates to an image processing device and an image processing method which adjusts a parameter representing a sense of depth of an image, and a non-transitory computer readable medium including a program for causing a computer to perform the image processing method.

2. Description of the Related Art

Many normal images (planar images and stereoscopic images) include information related to depth. Here, the information related to depth can be classified into monocular cues and binocular cues. Examples of the monocular cues include cues called pictorial cues such as blur, grain of texture, shading, overlapping, contrast, relative size, and linear perspective, as well as eye adjustment (focusing by the crystalline lens). Examples of the binocular cues include convergence (crossing of lines of sight of left and right eyes) and binocular parallax (difference between retinal images). By perceiving these pieces of information, a person can perceive a sense of depth even from an image projected on a plane.

However, when a large discrepancy occurs in the cues related to the depth (when they are far from a real view), it may cause a viewer to feel unnatural, uncomfortable, and visually fatigued from looking at an image. For example, in a stereoscopic image, visual fatigue can occur due to a discrepancy in the convergence and the adjustment. When a stereoscopic image is displayed on a two-dimensional flat display, the adjustment is on the display surface, so that a state occurs in which the convergence position is in midair. Therefore, it is different from natural eyesight and causes visual fatigue.

As a solution to the problem described above, JP 2002-223458 A and JP 2011-160302 A may be considered.

JP 2002-223458 A discloses a method in which when a stereoscopic image is displayed on a display screen, the position of the stereoscopic image is controlled so that the position is within a depth of focus of an eyeball optical system based on a calculation result of distance and depth between two images. JP 2002-223458 A describes that the position of the stereoscopic image is controlled to correspond to the position of the display screen, so that the convergence and the adjustment agree with each other and the visual fatigue is reduced.

JP 2011-160302 A discloses a method in which when a stereoscopic image is generated from a planar image and a depth map of the planar image, each of left and right images is generated based on the depth map and a depth of focus of an eyeball optical system, so that creation of stereoscopic image contents considering the visual fatigue is realized.

According to the methods described in JP 2002-223458 A and JP 2011-160302 A described above, it is possible to control the display position of a stereoscopic image by considering the depth of focus of the eyeball optical system and provide a comfortable stereoscopic image with less visual fatigue. However, the depth of focus of a human eyeball varies due to influence of ambient environmental light. Generally, the depth of focus is small in a dark room and is large in a bright room. Therefore, for example, when seeing stereoscopic image contents adjusted for a bright room in a dark room, visual fatigue may occur and impression received by a viewer changes due to environmental light.

In the above description, an example of the binocular cues is described. However, the same thing can be considered for the monocular cues. An example of “blur” will be described as an example of the monocular cues. When blur occurs in an object even when an object space (a space formed by a nearest object and a farthest object) displayed on a display is actually within the depth of focus, the object is not seen as the same as the actual object and it is considered that naturalness is lost.

### SUMMARY OF THE INVENTION

Preferred embodiments of the present invention adjust a sense-of-depth parameter (a parameter related to binocular cues and the monocular cues) according to environmental light in a viewing environment that is, according to a light environment, in an image processing device.

A first technical aspect of various preferred embodiments of the present invention provides an image processing device including a viewing environmental light information acquirer configured to acquire viewing environmental light information that is information related to environmental light in a viewing environment of a display device; and a sense-of-depth parameter adjustment amount calculator configured to calculate an adjustment amount of a sense-of-depth parameter of monocular cues and/or binocular cues used when the display device displays an image represented by image data based on the viewing environmental light information and auxiliary data to create a sense of depth of the image in the image data.

A second technical aspect of various preferred embodiments of the present invention provides the image processing device according to the first technical aspect described above, further including a user input configured to input a user operation indicating a reference position used to adjust the adjustment amount of the sense-of-depth parameter, wherein the sense-of-depth parameter adjustment amount calculator is configured to calculate the adjustment amount of the sense-of-depth parameter based on the viewing environmental light information, the auxiliary data, and user input information that is information inputted from the user input.

A third technical aspect of various preferred embodiments of the present invention provides the image processing device according to the first technical aspect described above, further including a user input configured to input a user operation indicating a reference position used to adjust the adjustment amount of the sense-of-depth parameter; and a viewing position detector configured to detect a position of a viewer with respect to the display device, wherein the sense-of-depth parameter adjustment amount calculator is configured to calculate the adjustment amount of the sense-of-depth parameter based on the viewing environmental light information, the auxiliary data, the user input information that is information inputted from the user input, and viewer position information indicating the position of the viewer which is detected by the viewing position detector.

A fourth technical aspect of various preferred embodiments of the present invention provides the image processing device according to the second or third technical aspect, wherein the user input is a contact or noncontact touch sensor and/or a visual line detection device configured to sense a visual line of a user.

A fifth technical aspect of various preferred embodiments of the present invention provides the image processing device according to the first technical aspect, further including a viewing position detector configured to detect a position of a viewer with respect to the display device, wherein the sense-of-depth parameter adjustment amount calculator is configured to calculate the adjustment amount of the sense-of-depth parameter based on the viewing environmental light information, the auxiliary data, and viewer position information indicating the position of the viewer which is detected by the viewing position detector.

A sixth technical aspect of various preferred embodiments of the present invention provides the image processing device according to the third or fifth technical aspect, wherein the viewing environmental light information is illumination information representing brightness of the viewing environment and/or luminance information representing display luminance of the display device, and the image processing device includes an image capturing device and is configured to detect any one or a plurality of the illumination information and/or the luminance information and the viewer position information at the same time based on captured image data that is captured by the image capturing device.

A seventh technical aspect of various preferred embodiments of the present invention provides the image processing device according to the third or fifth technical aspect, wherein the image processing device is used at a position spatially separated from the display device, and the image processing device includes a connection distance detector configured to detect a distance between the display device and the image processing device and the viewing position detector detects a position of a viewer with respect to the display device by using the distance.

An eighth technical aspect of various preferred embodiments of the present invention provides the image processing device according to any one of the first to fifth technical aspects, wherein the viewing environmental light information is illumination information representing brightness of the viewing environment and/or luminance information representing display luminance of the display device.

A ninth technical aspect of various preferred embodiments of the present invention provides the image processing device according to any one of the first to fifth technical aspects, wherein the viewing environmental light information is information representing viewer pupil diameter estimated from illumination information representing brightness of the viewing environment and/or luminance information representing display luminance of the display device.

A tenth technical aspect of various preferred embodiments of the present invention provides the image processing device according to the ninth technical aspect, wherein the sense-of-depth parameter adjustment amount calculator is configured to calculate or estimate depth of field information which the display device represents based on the information representing the viewer pupil diameter and to calculate the adjustment amount of the sense-of-depth parameter.

An eleventh technical aspect of various preferred embodiments of the present invention provides the image processing device according to any one of the first to tenth technical aspects, wherein the auxiliary data is mask data that specifies an adjustment position of the sense-of-depth parameter corresponding to a position of the image data and/or a depth map corresponding to the position of the image data.

A twelfth technical aspect of various preferred embodiments of the present invention provides the image processing device according to any one of the first to eleventh technical aspects, wherein the sense-of-depth parameter is an amount of blur.

A thirteenth technical aspect of various preferred embodiments of the present invention provides the image processing device according to any one of the first to eleventh technical aspects, wherein the sense-of-depth parameter is a binocular parallax amount.

A fourteenth technical aspect of various preferred embodiments of the present invention provides an image processing method including an acquisition step in which a viewing environmental light information acquirer acquires viewing environmental light information that is information related to environmental light in a viewing environment of a display device; and a calculation step in which a sense-of-depth parameter adjustment amount calculator calculates an adjustment amount of a sense-of-depth parameter of monocular cues and/or binocular cues used when the display device displays an image represented by image data based on the viewing environmental light information and auxiliary data to create a sense of depth of the image in the image data.

A fifteenth technical aspect of various preferred embodiments of the present invention provides a non-transitory computer-readable recording medium that records an image processing program for causing a computer to perform the image processing method according to the fourteenth technical aspect.

According to various preferred embodiments of the present invention, it is possible to adjust the sense-of-depth parameter according to the light environment in the viewing environment, or according to a state of the viewer, such as the position and the orientation of the viewer, in addition to the light environment in the viewing environment.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a configuration example of an image processing device according to a first preferred embodiment of the present invention.

FIG. 2 is a flowchart for explaining an image processing example of the image processing device of FIG. 1.

FIG. 3 is diagram illustrating a configuration example of a viewing environmental light information acquirer and a peripheral portion thereof in the image processing device of FIG. 1.

FIG. 4 is a flowchart for explaining a processing example of the viewing environmental light information acquirer of FIG. 3.

FIG. 5 is diagram illustrating a configuration example of a sense-of-depth parameter adjustment amount calculator and a peripheral portion thereof in the image processing device of FIG. 1.

FIG. 6 is a flowchart explaining a processing example of the sense-of-depth parameter adjustment amount calculator of FIG. 5.

FIG. 7 is a flowchart explaining an example of sense-of-depth parameter adjustment necessity determination processing in the processing of FIG. 6.

FIG. 8 is diagram illustrating another configuration example of the sense-of-depth adjustment amount calculator and a peripheral portion thereof in the image processing device of FIG. 1.

FIG. 9 is a diagram which compares a second preferred embodiment and a third preferred embodiment of the present invention.

FIG. 10 is diagram illustrating another configuration example of the sense-of-depth adjustment amount calculator and a peripheral portion thereof in the image processing device of FIG. 1.

FIG. 11 is diagram illustrating another configuration example of the viewing environmental light information acquirer and a peripheral portion thereof in the image processing device of FIG. 1.

FIG. 12 is a flowchart explaining a processing example of the viewing environmental light information acquirer in the image processing device of FIG. 11.

FIG. 13 is a diagram illustrating a configuration example of a display system including an image processing device according to a preferred embodiment of the present invention.

FIG. 14 is a flowchart explaining an example of stereoscopic display processing of an image in the display system of FIG. 13.

### DETAILED DESCRIPTION OF THE PREFERRED EMBODIMENTS

Hereinafter, preferred embodiments according to the present invention will be described with reference to the drawings.

### First Preferred Embodiment

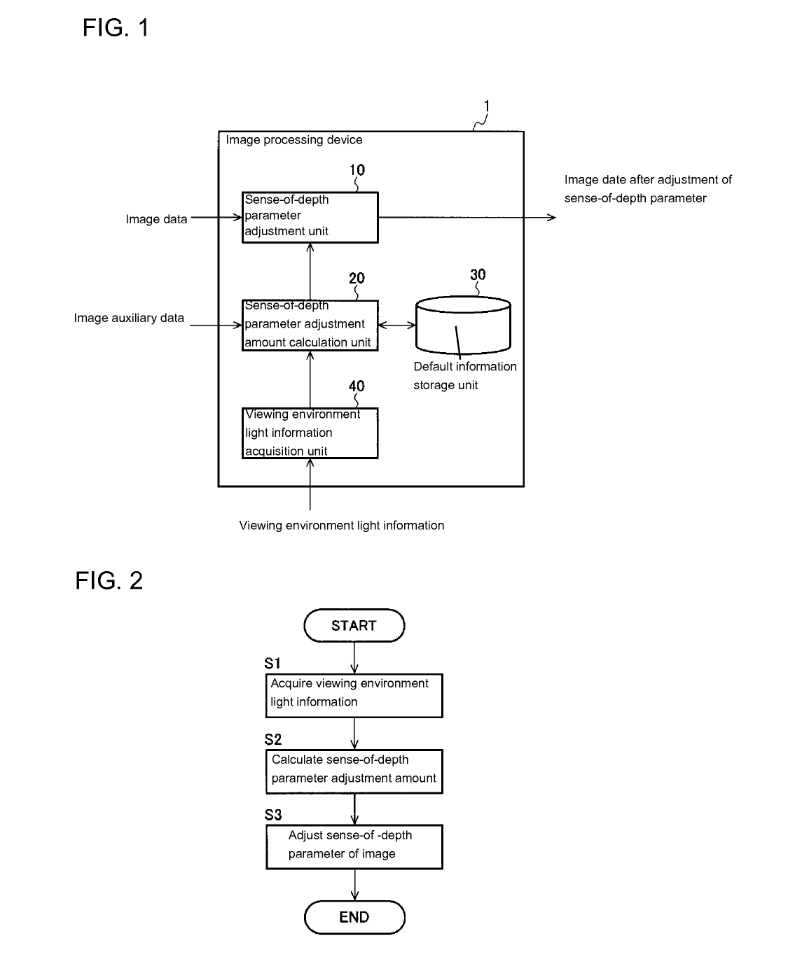

FIG. 1 is a diagram illustrating a configuration example of an image processing device according to a first preferred embodiment of the present invention. An image processing device 1 according to the present preferred embodiment preferably includes a viewing environmental light information acquirer 40 and a sense-of-depth parameter adjustment amount calculator 20.

The viewing environmental light information acquirer 40 is configured to acquire viewing environmental light information which is information related to environmental light in a viewing environment of a display device (that is, a viewing environment in which a viewer who views the display device is located). Here, the display device indicates a display device configured to display an image after image processing performed by the image processing device 1. The information related to environmental light mentioned here indicates information representing information of a light environment for viewing (that is, information representing how an image is seen). The information related to environmental light may indicate only ambient brightness. However, it is desirable that the information related to environmental light includes information representing a display luminance (screen luminance) of the display device as described later because the depth of focus of a human eyeball is affected by luminance of an image of the display device. Hereinafter, the information related to environmental light is also simply referred to as light information.

Image data to be processed by the image processing device includes, for example, image data outputted from a camera sensor in a device including a camera, image data recorded in a recording medium such as ROM (Read Only Memory), image data received from a server through a network, and image data that is received by a tuner or the like and converted into an image.

The sense-of-depth parameter adjustment amount calculator 20 is configured to calculate an adjustment amount of a sense-of-depth parameter used when the display device displays an image represented by image data based on the viewing environmental light information and image auxiliary data. The sense-of-depth parameter is a parameter representing a sense of depth of an image and is a parameter of the monocular cues and/or the binocular cues. The sense-of-depth parameter is not only used to represent a sense of depth when the display device displays image data as a stereoscopic image, but also used to represent a sense of depth such as an amount of blur when displaying a normal planar image. The sense-of-depth parameter can be said to be one of display parameters of the display device. The sense-of-depth parameter may be information included in the image auxiliary data or may be information obtained from the image auxiliary data by calculation. In each case, the sense-of-depth parameter adjustment amount calculator 20 is configured to calculate an adjustment amount of the sense-of-depth parameter.

The image auxiliary data is auxiliary data used to create a sense of depth of an image in image data. The image auxiliary data may be attached to the image data in association with the image data or may be included in the image data. The image auxiliary data is, for example, mask data that specifies an adjustment position of the sense-of-depth parameter corresponding to the position (pixel position) of the image data and/or data of a depth map (also referred to as a parallax map) corresponding to the position (pixel position) of the image data.

The depth map preferably includes, for example, (1) when the image data is stereoscopic image data, depth data calculated based on the stereoscopic image data, (2) depth data acquired from a distance measuring device corresponding to a camera device that captures an image, (3) depth data estimated from a 2D image by a 2D/3D conversion technique. It is preferable that the image auxiliary data is the mask data and/or the depth map. However, the image auxiliary data is not limited to these, but may be data used to create a sense of depth of an image.

The image processing device 1 illustrated in FIG. 1 preferably further includes a sense-of-depth parameter adjuster 10 and a default information storage 30. The default information storage 30 is configured to store default information used to obtain an adjustment amount calculated by the sense-of-depth parameter adjustment amount calculator 20. The sense-of-depth parameter adjustment amount calculator 20 is configured to calculate an adjustment amount of the sense-of-depth parameter based on the image auxiliary data, the viewing environmental light information from the viewing environmental light information acquirer 40, and the default information from the default information storage 30. The sense-of-depth parameter adjuster 10 generates an image whose sense-of-depth parameter is adjusted from the sense-of-depth parameter adjustment amount from the sense-of-depth parameter adjustment amount calculator 20 and input data (inputted image data to be displayed by the display device).

FIG. 2 illustrates an image processing example of the image processing device 1. In step S1, the viewing environmental light information acquirer 40 receives light information of a viewing environment and transmits the light information to the sense-of-depth parameter adjustment amount calculator 20. In step S2, the sense-of-depth parameter adjustment amount calculator 20 receives the viewing environmental light information from the viewing environmental light information acquirer 40, the default information from the default information storage 30, and the image auxiliary data, calculates the sense-of-depth parameter adjustment amount, and transmits the adjustment amount to the sense-of-depth parameter adjuster 10. In step S3, the sense-of-depth parameter adjuster 10 receives the sense-of-depth parameter adjustment amount from the sense-of-depth parameter adjustment amount calculator 20 and the image data and generates an image whose sense-of-depth parameter has been adjusted.

First, a specific example of the viewing environmental light information acquirer 40 will be described.

The viewing environmental light information received by the viewing environmental light information acquirer 40 includes illumination information representing brightness of the viewing environment (i.e., illumination information of the viewing environment) and luminance information representing the display luminance of the display device, and it is preferable to use both the illumination information and the luminance information as the viewing environmental light information. It is preferable that the luminance information is a value actually measured in the display device. However, the luminance information may be the maximum luminance that can be displayed by the display device, that is, the display capability of the display device (i.e., the maximum luminance that can be displayed when displaying white data), or may be an average value or a maximum value of luminance values (these are preferably estimated values) of pixels displayed on a screen when the image data to be displayed is actually displayed, which are calculated from pixel values of the image data to be displayed.

Here, the viewing environmental light information acquirer 40 receives, for example, room illumination information and display luminance information as the light information in an installation environment of the image processing device 1, estimates a viewer pupil diameter, and transmits information representing the viewer pupil diameter to the sense-of-depth parameter adjustment amount calculator 20 as a viewing environmental light information integration result. In this case, it is preferable that the sense-of-depth parameter adjustment amount calculator 20 is configured to calculate or estimate depth of field information which the display device should represent based on the information representing the viewer pupil diameter and to calculate the adjustment amount of the sense-of-depth parameter. The calculation method of the adjustment amount of the sense-of-depth parameter will be described later. However, the viewer pupil diameter need not be estimated, and in this case, the illumination information and/or the luminance information may be used without change. Although it is assumed that the viewer pupil diameter is estimated from the illumination information and the luminance information, the viewer pupil diameter may be estimated from either one of the illumination information and the luminance information.

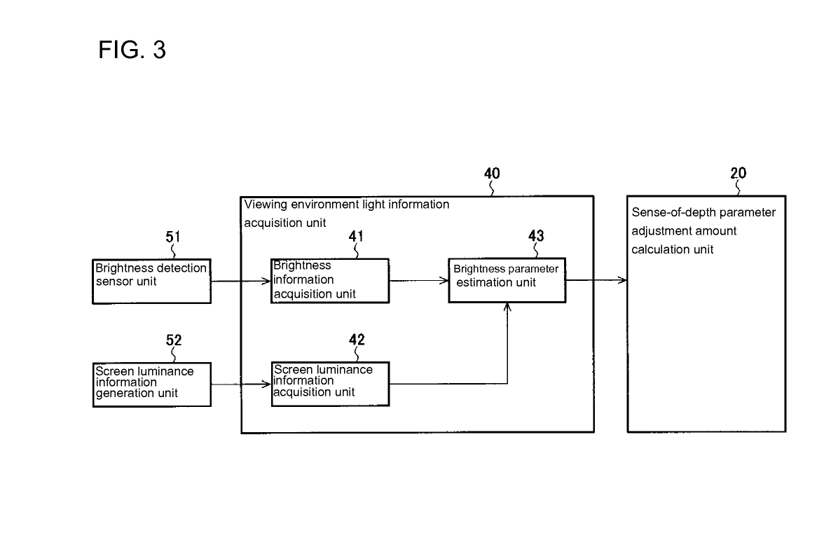

FIG. 3 illustrates a configuration example of the viewing environmental light information acquirer 40 and a peripheral portion thereof. The viewing environmental light information acquirer 40 is connected to a brightness detection sensor 51 that is configured to detect the illumination information (i.e., brightness information) and a screen luminance information generator 52 that is configured to generate screen luminance information as an example of the luminance information. The viewing environmental light information acquirer 40 includes a brightness information acquirer 41 that is configured to acquire the brightness information from the brightness detection sensor 51, a screen luminance information acquirer 42 that is configured to acquire the screen luminance information from the screen luminance information generator 52, and a brightness parameter estimator 43 that is configured to estimate a brightness parameter representing brightness perceived by a viewer based on the brightness information from the brightness information acquirer 41 and the screen luminance information from the screen luminance information acquirer 42.

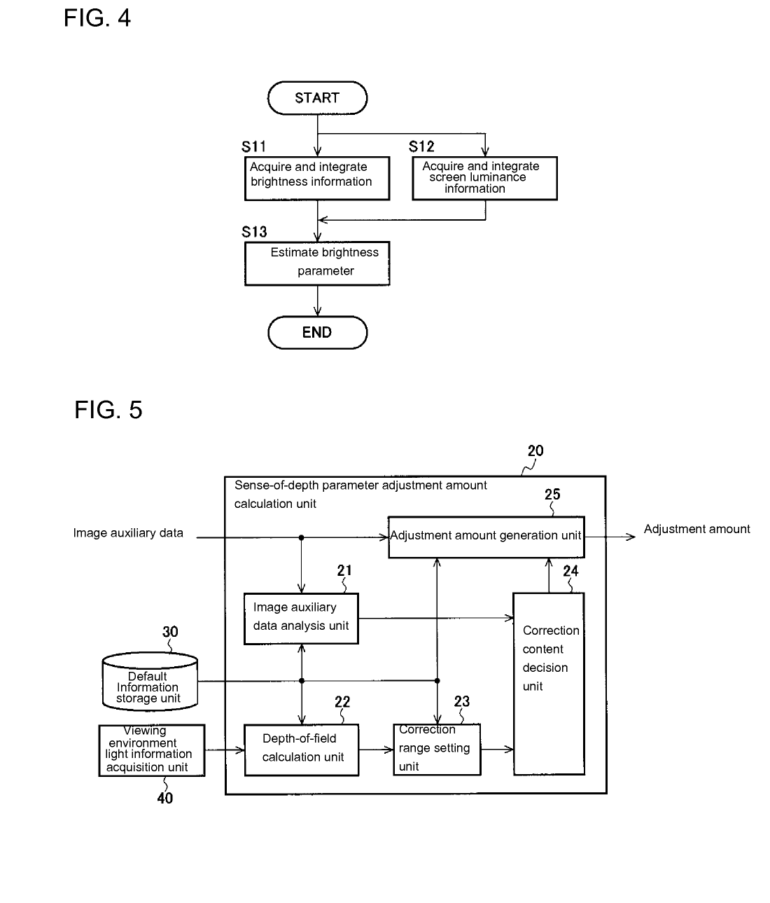

FIG. 4 illustrates a processing example of the viewing environmental light information acquirer 40. In step S11, the brightness information acquirer 41 is configured to acquire and integrate the brightness information from the brightness detection sensor 51 and to transmit the brightness information to the brightness parameter estimator 43. In step S12, the screen luminance information acquirer 42 is configured to acquire and integrate the screen luminance information from the screen luminance information generator 52 and to transmit the screen luminance information to the brightness parameter estimator 43. In step S13, the brightness parameter estimator 43 estimates the brightness parameter based on the brightness information from the brightness information acquirer 41 and the screen luminance information from the screen luminance information acquirer 42 and transmits the brightness parameter to the sense-of-depth parameter adjustment amount calculator 20.

More specifically, first, it is possible to use a configuration in which the brightness detection sensor 51 estimates brightness in an ambient environment by, for example, (1) having an illuminance sensor (array) and acquiring the brightness in the ambient environment by the illuminance sensor or (2) having a camera sensor and signal-processing image data acquired by the camera sensor. The brightness detection sensor 51 may integrate both the brightness information acquired from the illuminance sensor and the brightness information acquired from the camera sensor to generate integrated brightness information and transfer the integrated brightness information to the brightness parameter estimator 43.

For example, it is possible to use a configuration in which the screen luminance information generator 52 (1) receives image data inputted into the image processing device 1 and generates an average of luminance values in the entire screen as the screen luminance information, or (2) estimates an area of interest in an image from image data and generates luminance information of the area of interest as the screen luminance information, or (3) detects the orientation of a face of a viewer (or the orientation of line of sight) and the viewing position by a camera sensor, sets an area of interest based on the detection result, and generates luminance information of the area of interest as the screen luminance information. The screen luminance information generator 52 may preferably integrate pieces of the screen luminance information generated by two or three of the methods (1) to (3) described above to generate integrated brightness information and transfer the integrated brightness information to the screen luminance information acquirer 42. When both the brightness detection sensor 51 and the screen luminance information generator 52 include or use a camera sensor, it is preferable to use image data from a common camera.

For example, the brightness parameter estimator 43 is configured to estimate the viewer's pupil diameter as the brightness parameter. In general, a human's pupil diameter is about 2 mm to about 8 mm and is calculated based on, for example, the formula (1).

SIZE_{—}P=α×Illum+β×Lumin+γ (1)

Here, SIZE_P is the size of the pupil diameter, Illum is an illuminance value obtained from the brightness information acquirer 41, Lumin is a luminance value obtained from the screen luminance information acquirer 42, and α, β, and γ are arbitrary coefficients.

It is not desirable that the brightness parameter estimated by the brightness parameter estimator 43 largely varies in a discrete manner (for example, the pupil diameter does not change in a discontinuous manner), so that an output value of the brightness parameter estimated the previous time is held in a register or the like and, for example, smoothing is performed in a time direction as illustrated in the formula (2).

SIZE_{—}P′=η×SIZE_{—}P_{—}CUR+(1−η)×SIZE_{—}P_{—}PRE (2)

Here, SIZE_P′ is the size of the pupil diameter after the smoothing, SIZE_P_CUR is the size of the pupil diameter that is currently estimated, SIZE_P_PRE is the size of the pupil diameter that is previously estimated, and η is a smoothing coefficient.

The brightness parameter estimator 43 is configured to transmit the calculated size of the pupil diameter to the sense-of-depth parameter adjustment amount calculator 20 as the brightness parameter. The brightness parameter may simply be a viewing environment brightness intensity received by a viewer and may be outputted as discrete values such as, for example, “strong (3)”, “medium (2)”, “weak (1)”. The data update frequency of the viewing environmental light information acquirer 40 need not necessarily be matched with a frame rate of the image data.

Next, a specific example of the sense-of-depth parameter adjustment amount calculator 20 will be described. FIG. 5 illustrates a configuration example of the sense-of-depth parameter adjustment amount calculator 20 and a peripheral portion thereof. The sense-of-depth parameter adjustment amount calculator 20 preferably includes an image auxiliary data analyzer 21 configured to analyze data related to the sense-of-depth parameter to be adjusted from the image auxiliary data and a depth-of-field calculator 22 configured to calculate the depth of field. The sense-of-depth parameter adjustment amount calculator 20 further includes a correction range setter 23 configured to set a range in which the sense-of-depth parameter should be adjusted based on the depth of field information from the depth-of-field calculator 22 and the default information from the default information storage 30, a correction content decider 24 configured to decide the necessity of the adjustment based on an analysis result from the image auxiliary data analyzer 21 and correction range information from the correction range setter 23, and an adjustment amount generator 25 configured to determine the adjustment amount based on a decision result of the correction content decider 24.

Here, the default information storage 30 preferably holds information required for various calculations, such as, for example, a normal viewing distance of a viewer, the sense-of-depth parameter to be adjusted, the default value of the sense-of-depth parameter, the resolution (display resolution) and the aspect ratio of the display device connected to the image processing device 1 according to various preferred embodiments of the present invention, and a normal interocular distance.

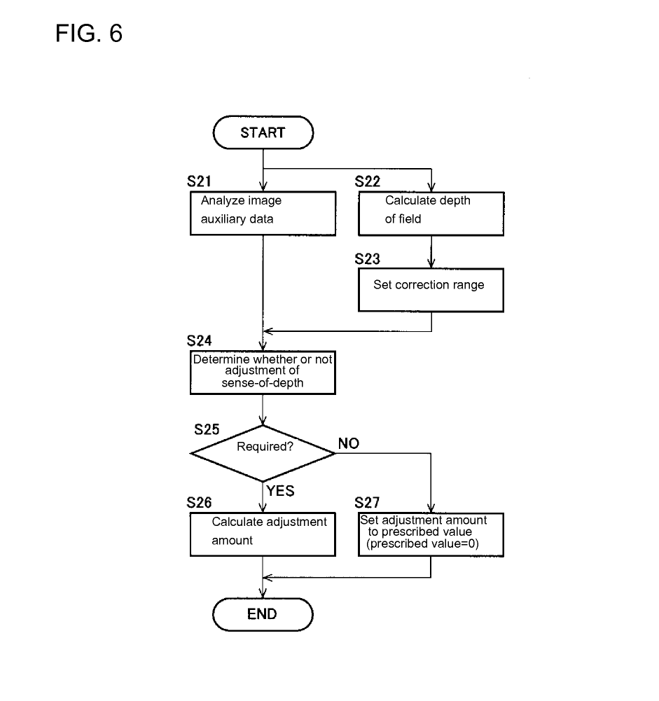

FIG. 6 illustrates a processing example of the sense-of-depth parameter adjustment amount calculator 20. In step S21, the image auxiliary data analyzer 21 is configured to analyze the sense-of-depth parameter from the image auxiliary data and the default information and outputs analysis data. The default information is preferably information such as, for example, “sense-of-depth parameter to be adjusted”, “display size”, “display resolution”, “normal viewing distance”, and “normal interocular distance”, which are obtained from the default information storage 30. When the sense-of-depth parameter to be adjusted is a binocular parallax amount, the depth map is received as the image auxiliary data and a corresponding binocular parallax amount (binocular parallax range) is analyzed. In this case, as the analysis data, a nearest distance (the nearest distance from the viewer's position that is determined as the origin) and a farthest distance (the farthest distance from the viewer's position that is determined as the origin), which are reproduced as a stereoscopic image when being displayed on the display device, and a range defined by the nearest distance and the farthest distance are outputted. In this way, as the sense-of-depth parameter, the binocular parallax amount preferably is used.

Here, an example of a calculation method of distance data will be described. When it is assumed that data of the depth map is a signed eight-bit value (−128 to 127) and pixel values of the data are the amount of deviation on the display, distance data D (x, y) is calculated by the formulae (3) to (6). It is defined that a case in which the depth data is positive is a short distance direction and a case in which the depth data is negative is a long distance direction.

if (M(x,y)≧0)

D(x,y)=Deye×Dview/(Deye+dot×M(x,y)) (3)

else if (M(x,y)<0 and dot×M(x,y)<Deye)

D(x,y)=Dview+dot×M(x,y)×Dview/(Deye−abs(dot×M(x,y))) (4)

else

D(x,y)=∞(infinite) (5)

Here, D(x, y) is the distance data at the coordinates (x, y), M(x, y) is a pixel value of the depth map at the coordinates (x, y), Deye is the interocular distance of the viewer, Dview is the viewing distance (distance from the viewer's position to the display screen), dot is the size of one pixel, and abs( ) is a function to obtain an absolute value. For example, when the display size is 52 inches, the display resolution is 1920×1080, the viewing distance Dview is three times the screen height, the interocular distance Deye of the viewer is 65 mm, and the pixel value M(x, y) of the depth map is 30, dot≈0.60 and Dview≈1943 mm are derived from the display size and the display resolution and D(x, y)≈1522 mm is derived because the formula (3) is applied.

In step S22, the depth-of-field calculator 22 calculates the depth of field based on information such as the brightness parameter from the viewing environmental light information acquirer 40 and the “normal viewing distance” from the default information storage 30. According to the example described above, a case in which the pupil size SIZE_P is received as the brightness parameter will be described. An example of formulae (approximation formulae) that can be used to calculate the depth of field (nearest point, farthest point) is illustrated by the formulae (6) and (7).

DN=Dview(H−f)/(H+Dview−2f) (6)

DF=Dview(H−f)/(H−Dview) (7)

Here, DN is the nearest point distance of the depth of field (the distance from the viewer's position that is determined as the origin), DF is the farthest point distance of the depth of field (the distance from the viewer's position that is determined as the origin), Dview is the viewing distance (the distance from the viewer's position to the display surface), H is the hyperfocal distance, and f is the focal distance. The hyperfocal distance H is calculated by the formula (8).

H=f×SIZE_{—}P/c (8)

Here, SIZE_P is the brightness parameter (the pupil size) obtained from the viewing environmental light information acquirer 40 and c is a permissible circle of confusion constant.

In step S23, the correction range setter 23 is configured to set the correction range by the sense-of-depth parameter adjustment amount from the depth of field information from the depth-of-field calculator 22 and the default information such as the “sense-of-depth parameter to be adjusted” and the “display size” from the default information storage 30, and outputs the correction range as range setting data. In other words, when the sense-of-depth parameter to be adjusted is the binocular parallax amount, a corresponding depth of field range based on the depth of field information is set. In this case, a depth of field nearest distance, a depth of field farthest distance, and a range defined by these distances are outputted as correction range data.

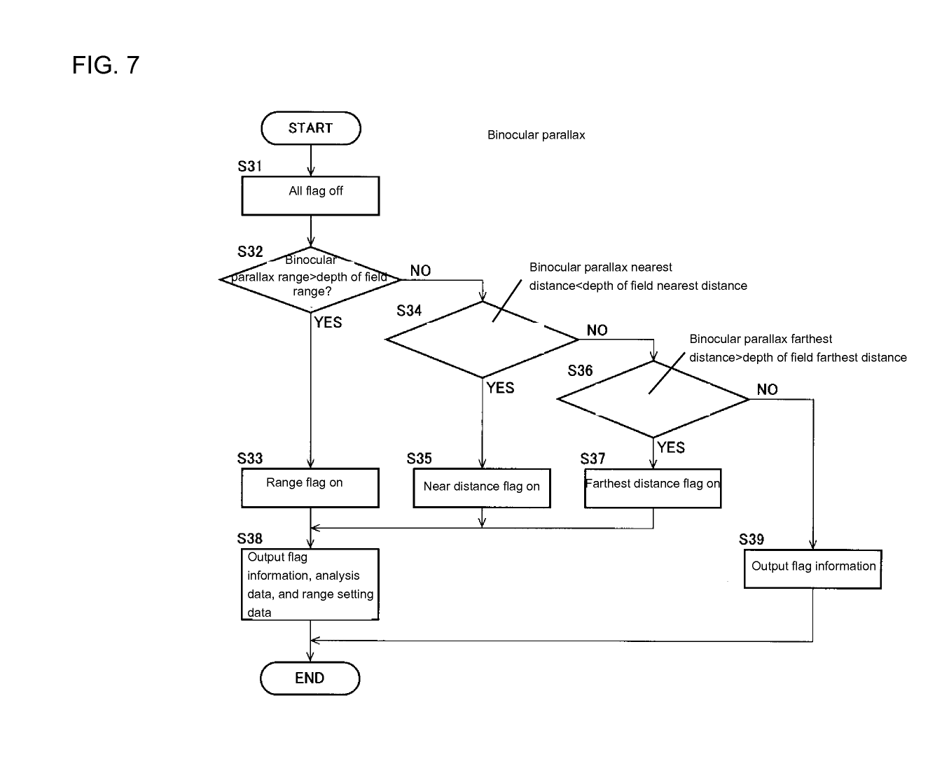

In step S24, the correction content decider 24 decides or determines whether or not the adjustment of the sense-of-depth parameter is required according to the flow in FIG. 7. The processing example of FIG. 7 is an example of a case in which the binocular parallax amount (i.e., a value related to the binocular parallax) is preferably used as analysis data and a value related to the depth of field is preferably used as range setting data.

In step S31 in FIG. 7, all decision flags of the sense-of-depth parameter adjustment (including, for example, a nearest distance flag, a farthest distance flag, and a range flag) are initialized to OFF. In step S32, a determination of binocular parallax range> depth of field range is performed by using the “binocular parallax range” from the image auxiliary data analyzer 21 and the “depth of field range” from the correction range setter 23.

When step S32 is YES, step S33 is performed. When step S32 is NO, step S34 is performed. In step S33, the range flag of the decision flags is set to ON. In step S34, a determination of binocular parallax nearest distance< depth of field nearest distance (a determination of whether or not the binocular parallax nearest distance is nearer to the viewer's position) is performed by using “binocular parallax nearest distance” from the image auxiliary data analyzer 21 and the “depth of field nearest distance” from the correction range setter 23.

When step S34 is YES, step S35 is performed. When step S34 is NO, step S36 is performed. In step S35, the nearest distance flag of the decision flags is set to ON. In step S36, a determination of binocular parallax farthest distance> depth of field farthest distance (i.e., a determination of whether or not the binocular parallax farthest distance is farther from the viewer's position) is performed by using “binocular parallax farthest distance” from the image auxiliary data analyzer 21 and the “depth of field farthest distance” from the correction range setter 23. When step S36 is YES, step S37 is performed. When step S36 is NO, all the flags are not changed and step S39 is performed.

In step S37, the nearest distance flag of the decision flags is set to ON. In step S38, the correction content decider 24 transmits the analysis data from the image auxiliary data analyzer 21, the range setting data from the correction range setter 23, and information of each decision flag (i.e., flag information) to the adjustment amount generator 25. In step S39, the correction content decider 24 transmits only the decision flags (in this case, all the decision flags are OFF) to the adjustment amount generator 25.

After processing step S24 in FIG. 6 in this way, in step S25, when any one of the decision flags transmitted from the correction content decider 24 is ON, that is, when it is determined that adjustment of the sense-of-depth parameter is required, (when step S25 is YES), step S26 is performed. On the other hand, when each decision flag is OFF (when step S25 is NO), step S27 is performed.

In step S26, when the range flag of the determination flags is ON, the adjustment amount generator 25 sets the adjustment amount so that the binocular parallax range=the depth of field range, the binocular parallax nearest distance=the depth of field nearest distance, and the binocular parallax farthest distance=the depth of field farthest distance are established. When the nearest distance flag of the determination flags is ON, the adjustment amount generator 25 sets the adjustment amount so that the binocular parallax nearest distance=the depth of field nearest distance is established. When the farthest distance flag of the determination flags is ON, the adjustment amount generator 25 sets the adjustment amount so that the binocular parallax farthest distance=the depth of field farthest distance is established. In other words, the adjustment amount generator 25 sets the adjustment amount so that all binocular parallax data are within the depth of field. Although various setting methods can be considered, these methods are not referred to because they are not directly related to the content of various preferred embodiments of the present invention. In step S27, the adjustment amount generator 25 outputs a prescribed value 0 as the adjustment amount.

The sense-of-depth parameter adjuster 10 is configured to generate image data whose sense-of-depth parameter has been adjusted based on data of the adjustment amount calculated in this way.

It is not necessarily required to use all the decision flags. It is possible to directly transmit the analysis data of the image auxiliary data and the depth of field data to the adjustment amount generator 25 not through the correction content decider 24 and perform the processing of FIG. 7 assuming that all the flags are ON.

With the configuration described above, it is possible to generate an image whose sense-of-depth parameter (in this example, the binocular parallax amount, that is, the binocular parallax range) is adjusted by estimating the range (the depth of field) in which the sense-of-depth parameter should be adjusted according to the light environment in the viewing environment. The depth of focus varies depending on the viewing environment, so that a comfortable depth range is not necessarily controlled by the techniques of JP 2002-223458 A and JP 2011-160302 A. However, in the present preferred embodiment, the light information in the viewing environment is detected and the field of depth of the viewer is calculated based on the light information, so that the sense-of-depth parameter preferably is controlled according to the light information in the viewing environment.

### Second Preferred Embodiment

Next, a second preferred embodiment of the present invention will be described. In the second preferred embodiment of the present invention, in the sense-of-depth parameter adjustment amount calculator 20 in FIG. 1, an example of an operation of a case in which an “amount of blur (an example of the monocular cues)” is specified as the sense-of-depth parameter will be described. Specifically, in the present preferred embodiment, the processing of steps S21 to S25 in FIG. 6 is preferably the same as that of the first preferred embodiment and the operation in step S26 is different from that of the first preferred embodiment.

In step S26 of the present preferred embodiment, when the range flag of the decision flags is ON, the adjustment amount generator 25 in FIG. 5 calculates the adjustment amount (the amount of blur) by the formulae (9) and (10) based on a depth map D(x, y) given as the image auxiliary data and the depth of field information from the correction content decider 24.

if (D(x,y)<DN)

ADJ(x,y)=G(DN−D(x,y)) (9)

if (DF<D(x,y))

ADJ(x,y)=G(D(x,y)−DF) (10)

Here, ADJ(x, y) is the adjustment amount (the amount of blur) for the coordinates (x, y), DN is the depth of field nearest distance, DF is the depth of field farthest distance, D(x, y) is the depth map at the coordinates (x, y), and G( ) is a Gaussian function. In other words, the amount of blur is adjusted so that the farther from the nearest distance position or the farthest distance position of the depth of field, the greater the amount of blur (however, the amount of bluer is saturated at a certain value). When the nearest distance flag of the decision flags is ON, the adjustment amount is calculated by the formula (9). When the farthest distance flag of the decision flags is ON, the adjustment amount is calculated by the formula (10).

By the configuration described above, it is possible to generate an image whose sense-of-depth parameter (in this example, the amount of blur) is adjusted by estimating the range (i.e., the depth of field) in which the sense-of-depth parameter should be adjusted according to the light environment in the viewing environment.

### Third Preferred Embodiment

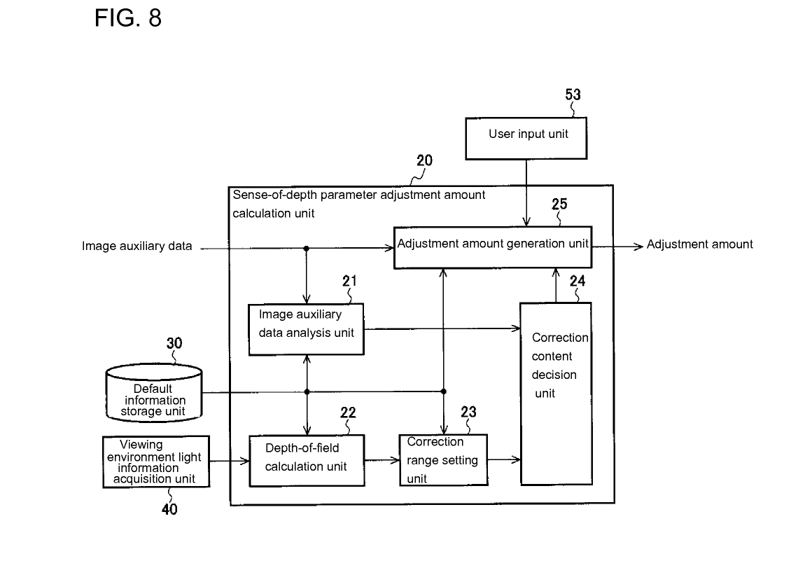

Next, a third preferred embodiment of the present invention will be described. In the third preferred embodiment of the present invention, as illustrated in the configuration example of the sense-of-depth parameter adjustment amount calculator 20 and a peripheral portion thereof in FIG. 8, for example, a configuration in which a user input 53 is added to the configuration of the second preferred embodiment is preferably used. The user input 53 is configured to receive a user operation indicating a reference position (for example, a reference position of the depth of field) to adjust the adjustment amount of the sense-of-depth parameter. The sense-of-depth parameter adjustment amount calculator 20 of the present preferred embodiment is configured to calculate the adjustment amount of the sense-of-depth parameter based on the viewing environmental light information acquired by the viewing environmental light information acquirer 40, the image auxiliary data, and user input information (reference position information) that is information inputted from the user input 53.

In the user input 53, for example, coordinates (px, py) of image data (image auxiliary data) are given as a user input. Then, in step S26 of the present preferred embodiment, when the range flag of the decision flags is ON, the adjustment amount generator 25 calculates the adjustment amount (the amount of blur) by the formulae (11) and (12) based on a depth map D (x, y) given as the image auxiliary data, the depth of field information from the correction content decider 24, and the user input coordinates (px, py).

if (D(x,y)<DN)

ADJ(x,y)=G(DN−(D(x,y)+DP)) (11)

if (DF<D(x,y))

ADJ(x,y)=G((D(x,y)+DP)−DF) (12)

Here, the formulae (11) and (12) are the same as the formulae (9) and (10) except for DP. DP is calculated by the formula (13).

DP=Dview−D(px,py) (13)

Here, Dview is the same as Dview in the formulae (6) and (7) or a position at any distance in the depth of field and D(px, py) is a depth value of the image auxiliary data (depth map) corresponding to the position of the coordinates (px, py) specified by the user input. In other words, it is possible to set an arbitrary position of an image as the reference position of the depth of field by an input of the user. When the nearest distance flag of the decision flags is ON, the adjustment amount is calculated by the formula (11). When the farthest distance flag of the decision flags is ON, the adjustment amount is calculated by the formula (12).

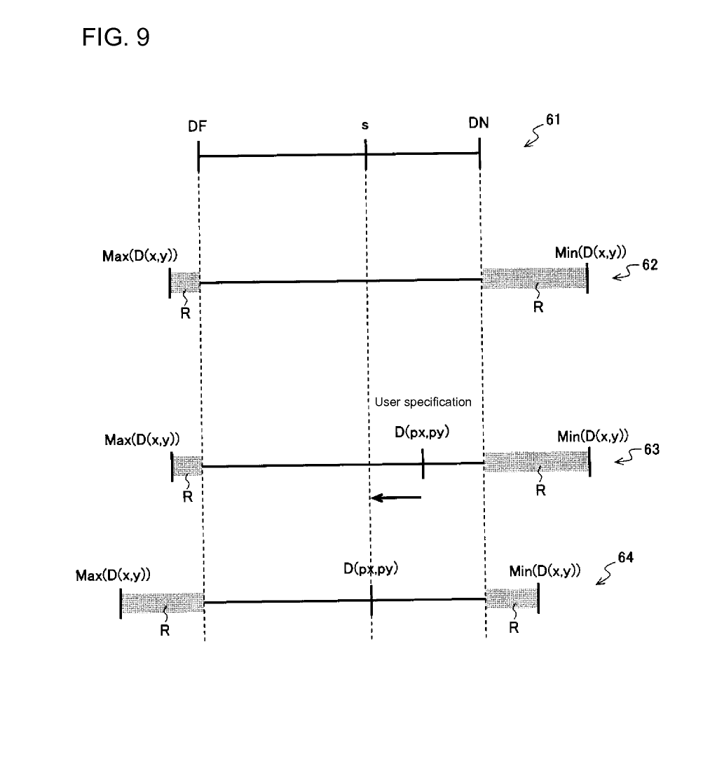

FIG. 9 illustrates a conceptual diagram providing a comparison between the second preferred embodiment and the third preferred embodiment of the present invention. A case will be described in which the amount of blur is adjusted for an image in an image depth range 62 represented by a range between Max(D(x, y)) and Min(D(x, y)) in an environment of a depth of field range 61 as illustrated in FIG. 9. Here, it is assumed that s is the reference position of the depth of field (for example, s=Dview=the normal viewing distance). The image depth range 62 is greater than the depth of field range 61, so that an area nearer than the nearest distance position of the depth of field or an area farther than the farthest distance position of the depth of field occurs. In the second preferred embodiment, the amount of blur is adjusted for these areas so that the farther from the nearest distance position or the farthest distance position, the greater the amount of blur.

For the third preferred embodiment, the processing for the image depth range 62 will be described with reference to the image depth range 63. Here, the image depth range 63 is a range in which a position D(px, py) specified by the user is indicated in the image depth range 62. In the third preferred embodiment, the image depth range 62 is shifted (as indicated by an arrow in the image depth range 63) so that the position D(px, py) specified by the user is the depth position of the reference position s. Therefore, in the third preferred embodiment, the position of the image depth range 63 is moved to the position of the image depth range 64, so that ranges R (shown in gray in FIG. 9) in which the amount of blur is adjusted change.

Regarding a method of specifying the coordinates by an input of the user from the user input 53, the following can be considered: (1) specifying the coordinates of image data displayed on the display device of one of the various preferred embodiments of the present invention that performs stereoscopic display or a display device, which is prepared separately to input information, through an input device such as a mouse, or (2) displaying image data on a touch sensor type display device of one of the various preferred embodiments of the present invention that performs stereoscopic display or a touch sensor type display device, which is prepared separately to input information, and specifying the coordinates of the image data, or (3) determining the coordinates on the image data on which the user keeps an eye by using an eye tracking device or the like. In this way, it is preferable that the user input 53 is a contact or noncontact touch sensor and/or a visual line detection device that senses the visual line of the user.

With the configuration described above, it is possible to generate an image whose sense-of-depth parameter is adjusted by estimating the range (the depth of field) in which the sense-of-depth parameter should be adjusted according to the light environment in the viewing environment and an input related to an area of interest of the user. Although the present preferred embodiment is described by using the amount of blur as the sense-of-depth parameter, the binocular parallax amount is capable of being used as the sense-of-depth parameter in the same manner as in the first preferred embodiment, for example.

### Fourth Preferred Embodiment

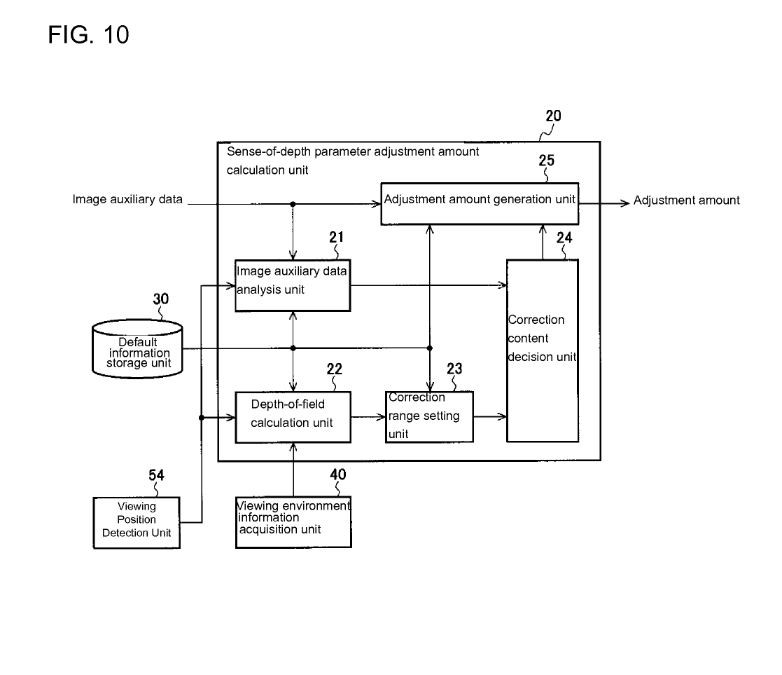

Next, a fourth preferred embodiment of the present invention will be described. In the fourth preferred embodiment of the present invention, a configuration in which viewer position information is detected will be described. In the present preferred embodiment, as illustrated in a configuration example of the sense-of-depth parameter adjustment amount calculator 20 and a peripheral portion thereof in FIG. 10, for example, a viewing position detector 54 is further added to the configuration of FIG. 5.

The viewing position detector 54 is configured to detect the position of the viewer with respect to the display device, that is, a positional relationship between the display device and the viewer. It is desirable that the viewing position detector 54 is provided on the side of the display device and the image processing device 1 receives information of the position from the display device. However, if the viewing position detector 54 is provided on the side of the image processing device 1, an appropriate adjustment amount is obtained assuming that the viewing position detector 54 is installed close to the display device.

Regarding a method of detecting the viewer's position, for example, the following can be considered: (1) detecting the viewer's position by a distance measuring sensor, (2) detecting a position where the viewer operates by a remote control or the like, (3) detecting the viewer's position by using various tracking devices, and (4) detecting a face position of the viewer by a camera sensor and estimating the position based on parameters of face recognition. Although the detection of the viewer's position is described in the above description, in practice, only the position of a face (the position of an eye ball) may be detected.

In the first to the third preferred embodiments, the image auxiliary data analyzer 21, the depth-of-field calculator 22, and the adjustment amount generator 25 preferably use the default information from the default information storage 30 as the position of Dview. However, in the present preferred embodiment, it is possible to calculate the adjustment amount suitable for the viewer's position by using the viewer position information indicating the position of the viewer which is detected by the viewing position detector 54. Specifically, in the present preferred embodiment, the sense-of-depth parameter adjustment amount calculator 20 is configured to calculate the adjustment amount of the sense-of-depth parameter based on the viewing environmental light information acquired by the viewing environmental light information acquirer 40, the image auxiliary data, and the viewer position information indicating the position of the viewer which is detected by the viewing position detector 54. Other configurations and application examples are preferably the same as those of the first to the third preferred embodiments. For example, also in the present preferred embodiment, the adjustment amount of the sense-of-depth parameter may be calculated by additionally using the user input information which is information inputted from the user input 53 illustrated in FIG. 8.

Regarding setting of the viewing distance when a plurality of viewers are detected, the following can be considered: (1) using the viewing distance of one viewer who most directly faces the screen, (2) using the viewing distance of an average of the distances (the center of gravity) of all the viewers, and (3) using the viewing distance of a weighted average of the viewing distances of all the viewers, which is calculated according to the orientations of the viewers to the screen.

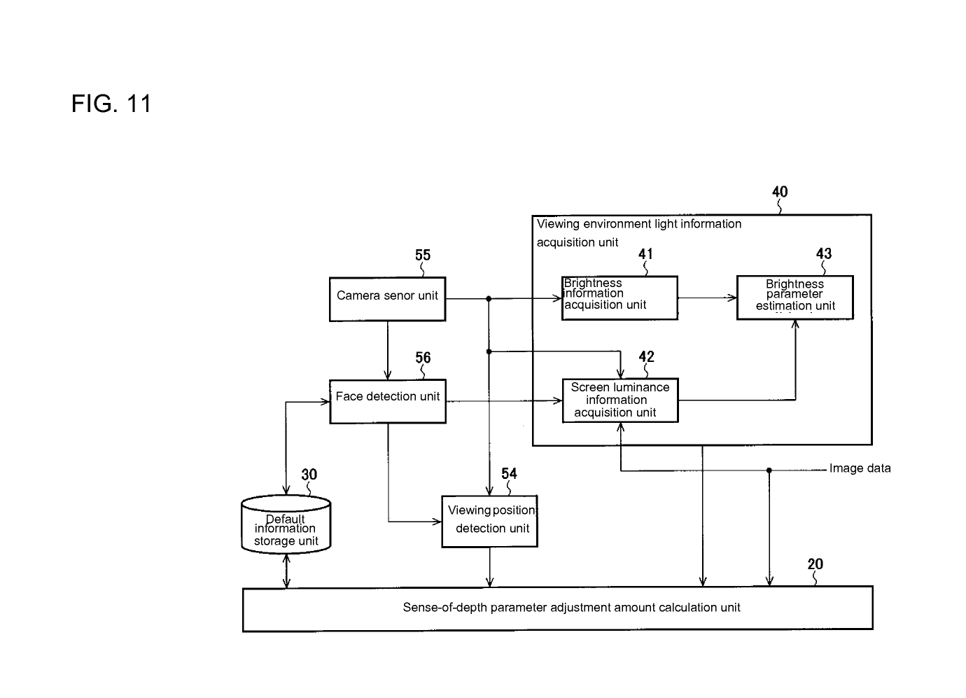

As described above, the brightness detection sensor 51 and the screen luminance information generator 52 in FIG. 3 and the viewing position detector 54 of the present preferred embodiment can use a camera sensor to acquire various information. Therefore, as illustrated in a configuration example of the viewing environmental light information acquirer 40 and a peripheral portion thereof in FIG. 11, it is possible to cause the same camera sensor 55 to acquire captured image data (camera image data).

The camera sensor 55 is preferably an image capturing device such as, for example, a camera sensor array and may be included in the image processing device 1. As illustrated in the configuration example in FIG. 11, the output from the camera sensor 55 is inputted into the brightness information acquirer 41, the screen luminance information acquirer 42, a face detector 56, and the viewing position detector 54. In this way, when the image processing device 1 preferably uses the illumination information and/or the luminance information as the viewing environmental light information and detects the position of the viewer, the image processing device 1 detects any one or a plurality of the illumination information and/or the luminance information and the viewer position information at the same time based on the captured image data that is captured by the image capturing device. Of course, as described above, even when both the illumination information and the luminance information are used as the viewing environmental light information, only either one of the illumination information and the luminance information may be detected by the image capturing device and the information that is not detected may be detected by another device.

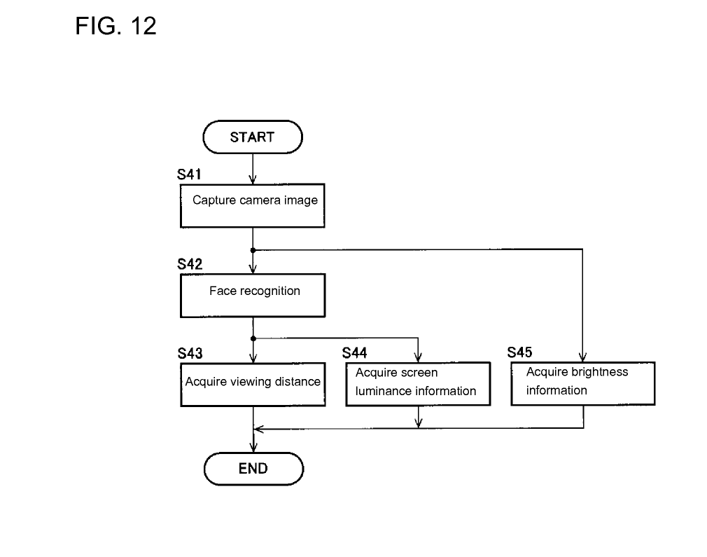

FIG. 12 illustrates a processing example of the above operation. In step S41, a camera image from the camera sensor 55 is captured. In step S42, the face detector 56 refers to the camera image and a database (DB) for face recognition recorded in the default information storage 30 and performs face recognition. In step S43, the viewing position detector 54 detects the position of the viewer based on a face recognition result from the face detector 56 and the camera image and transmits the viewer position information to the sense-of-depth parameter adjustment amount calculator 20.

In step S44, the screen luminance information acquirer 42 generates the screen luminance information based on the camera image, the image data, and the face recognition result from the face detector 56, and transmits the screen luminance information to the brightness parameter estimator 43. In step S45, the brightness information acquirer 41 acquires illuminance information based on the camera image and transmits the illuminance information to the brightness parameter estimator 43. By such a method, it is possible to extract various data from the same camera sensor 55.

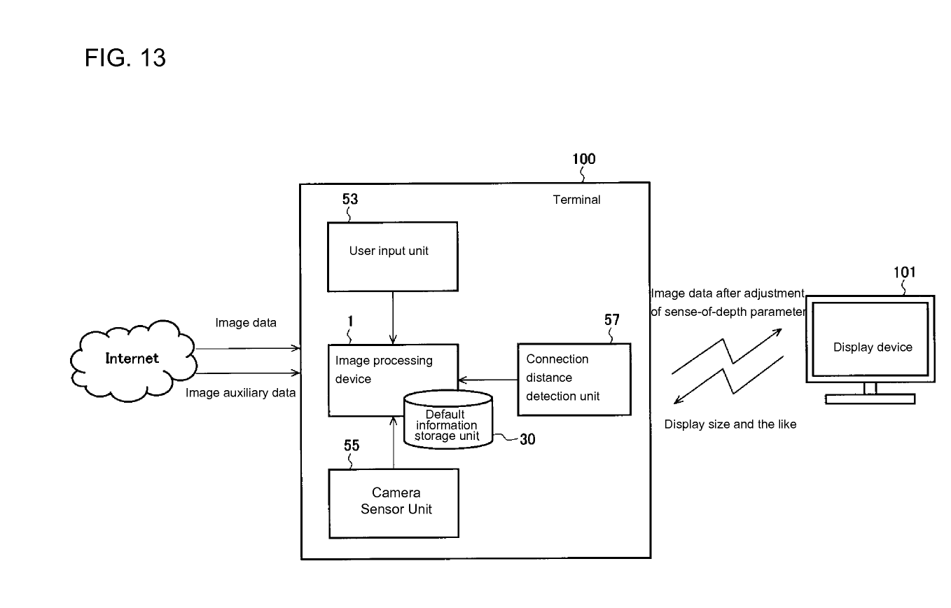

As illustrated in a configuration example of a display system including the image processing device according to various preferred embodiments of the present invention in FIG. 13, the image processing device 1 may be installed in a small terminal 100 beside a viewer, and image data whose sense-of-depth parameter has been adjusted may be transmitted to a display device 101 installed at a position spatially separated from the small terminal 100. The terminal 100 includes the image processing device 1, the user input 53, the camera sensor 55, and a connection distance detector 57. The terminal 100 is preferably connected to a storage area (for example, a server accessible via the Internet) in which the image data and the image auxiliary data are held, reads the image data and the image auxiliary data from the storage area, generates image data whose sense-of-depth parameter has been adjusted, and transmits the image data whose sense-of-depth parameter has been adjusted to the display device 101.

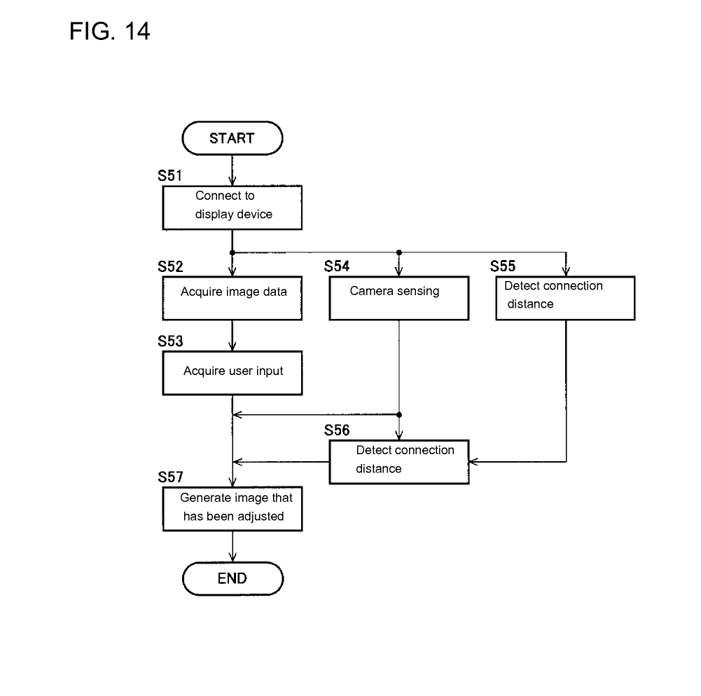

FIG. 14 illustrates an example of image stereoscopic display processing of the display system described above. In the display system, the terminal 100 including the image processing device 1 is used at a position spatially separated from the display device 101, which is a display of a stereoscopic image, (that is, a display device configured to display an image on which image processing has been performed). Therefore, in step S51, the terminal 100 first establishes communication with (connects to) the display device 101, receives various information such as the display size from the display device 101, and writes the information to the default information storage 30 as the default information. In step S52, the terminal 100 acquires the image data and the image auxiliary data from a tuner, a server on the Internet, or the like. In step S53, the terminal 100 displays the image data by using, for example, a touch sensor type display as the user input 53, causes the viewer to specify coordinates, and transmits the specified coordinates (x, y) to the image processing device 1.

In step S54, the camera sensor 55 performs steps S41 to S45 in FIG. 12. In step S55, the connection distance detector 57 detects a distance between the terminal 100 and the display device 101. Here, regarding the detection method of the distance between the terminal 100 and the display device 101, for example, the connection distance detector 57 is an image capturing device such as a camera sensor that is configured to capture an image of the display device 101, so that the connection distance detector 57 can estimate the distance by comparing the size of the display device 101 projected in the camera image on the image with display size information recorded in the default information storage 30.

In step S56, the image processing device 1 calculates a relative distance between a position of the face of the viewer and the display device 101 from the distance between the terminal and the display device obtained from the connection distance detector 57 and the distance between the terminal and the face obtained from the camera sensor 55. In this way, for the terminal 100 (including the image processing device 1) located at a position separated from the display device 101, it is preferable that the viewing position detector 54 is configured to detect the position of the viewer with respect to the display device 101 by using the distance detected by the connection distance detector 57.

Of course, when the display device 101 is arranged at a position separated from the terminal 100 in this way, the display device 101 may include the camera sensor 55 and transmit information indicating the position of the viewer with respect to the display device 101 acquired by the camera sensor 55 to the terminal 100 (that is, the image processing device 1).

In step S57, the image processing device 1 is configured to generate image data with a sense-of-depth parameter that has been adjusted based on the image data, the image auxiliary data, the user input information from the user input 53, the viewing environmental light information from the camera sensor 55, and the distance information between the position of the face of the viewer and the display device 101 calculated in step S56, and transmits the image data whose sense-of-depth parameter has been adjusted to the display device 101.

By the configuration described above, even when the image processing device 1 and the display device 101 are separated from each other, it is possible to generate and display an image whose sense-of-depth parameter is adjusted by estimating the range in which the sense-of-depth parameter should be adjusted based on the depth of field according to the light environment in the viewing environment and a state such as, for example, the position and the orientation of the viewer. Although the present preferred embodiment is described by using the amount of blur as the sense-of-depth parameter as a non-limiting example, the binocular parallax amount can be used as the sense-of-depth parameter in the same manner as in the first preferred embodiment, for example.

In each preferred embodiment described above, the configurations illustrated in the attached drawings are just an example, and the preferred embodiments are not limited to these configurations, but can be appropriately changed within a range where the effects of the present invention are exerted. Further, the preferred embodiments can be appropriately modified and implemented without departing from the scope of the present invention.

In the description of the preferred embodiments described above, each element for realizing a function is described as a component different from each other. However, in practice, the preferred embodiments need not have such components that can be clearly separated and identified. The image processing device that realizes the functions of the preferred embodiments may provide elements for performing functions, for example, by using components for each function located at different positions from each other or may include all the elements in one single component. In other words, any preferred embodiment may have individual elements for each function.

For example, each element of the image processing device according to various preferred embodiments of the present invention can preferably be realized by hardware such as, for example, a CPU (Central Processing Unit), a non-transitory computer-readable memory, a bus, an interface, and peripheral devices, and software that can be executed on the hardware. Instead of the CPU, a microprocessor or a DSP (Digital Signal Processor) can be used. A portion or all of the hardware can be implemented as an IC (Integrated Circuit) chip set. In this case, the software may be stored in the non-transitory computer-readable memory. All of the elements of various preferred embodiments of the present invention may be configured as hardware. In this case, in the same manner, a portion or all of the hardware can be mounted as an IC chip set.

The software (program) for realizing the functions described in the above preferred embodiments is preferably recorded in a non-transitory computer-readable recording medium, and processing of each component may be performed by causing a computer system such as a personal computer to read the program recorded in the recording medium and causing a CPU in the computer system to execute the program. The “computer system” here includes OS (Operating System) and hardware such as peripheral devices. When the “computer system” uses a WWW system, the “computer system” includes a home page providing environment (or display environment).

The “non-transitory computer-readable recording medium” is a preferably a portable medium such as, for example, a flexible disk, a magnet-optical disk, ROM, and a CD-ROM or a storage device such as, for example, a hard disk included in the computer system. While the image processing device according to various preferred embodiments of the present invention has been described, as illustrated in the flowcharts of process flow, the present invention may have a form of an image processing method including the following acquisition step and calculation step. The acquisition step is a step in which the viewing environmental light information acquirer acquires the viewing environmental light information that is information related to the environmental light in the viewing environment of the display device. The calculation step is a step in which the sense-of-depth parameter adjustment amount calculator is configured to calculate the adjustment amount of the sense-of-depth parameter of the monocular cues and/or the binocular cues used when the display device displays an image represented by image data based on the viewing environmental light information and auxiliary data for creating a sense of depth of the image in the image data. Other application examples are as described in the description of the image processing device, so that the description thereof is omitted.

In other words, the program itself is a program for causing a computer to perform the image processing method. Specifically, the program is a program stored on a non-transitory computer-readable medium for causing a computer to perform a step of acquiring the viewing environmental light information that is information related to the environmental light in the viewing environment of the display device and a step of calculating the adjustment amount of the sense-of-depth parameter of the monocular cues and/or the binocular cues used when the display device displays an image represented by image data based on the viewing environmental light information and auxiliary data for creating a sense of depth of the image in the image data. Other application examples are as described in the description of the image processing device, so that the description thereof is omitted.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-16. (canceled)

17. An image processing device comprising:
a viewing environmental light information acquirer configured to acquire viewing environmental light information that is information related to environmental light in a viewing environment of a display device; and
a sense-of-depth parameter adjustment amount calculator configured to calculate an adjustment amount of a sense-of-depth parameter of monocular cues and/or binocular cues used when the display device displays an image represented by image data based on the viewing environmental light information and auxiliary data to create a sense of depth of the image in the image data.

18. The image processing device according to claim 17, further comprising:
a user input configured to input a user operation indicating a reference position used to adjust the adjustment amount of the sense-of-depth parameter; wherein
the sense-of-depth parameter adjustment amount calculator is configured to calculate the adjustment amount of the sense-of-depth parameter based on the viewing environmental light information, the auxiliary data, and user input information that is information inputted from the user input.

19. The image processing device according to claim 17, further comprising:
a user input configured to input a user operation indicating a reference position used to adjust the adjustment amount of the sense-of-depth parameter; and
a viewing position detector configured to detect a position of a viewer with respect to the display device; wherein
the sense-of-depth parameter adjustment amount calculator is configured to calculate the adjustment amount of the sense-of-depth parameter based on the viewing environmental light information, the auxiliary data, the user input information that is information inputted from the user input, and viewer position information indicating the position of the viewer which is detected by the viewing position detector.

20. The image processing device according to claim 18, wherein the user input is a contact or noncontact touch sensor and/or a visual line detection device configured to sense a visual line of a user.

21. The image processing device according to claim 17, further comprising:
a viewing position detector configured to detect a position of a viewer with respect to the display device; wherein
the sense-of-depth parameter adjustment amount calculator is configured to calculate the adjustment amount of the sense-of-depth parameter based on the viewing environmental light information, the auxiliary data, and viewer position information indicating the position of the viewer which is detected by the viewing position detector.

22. The image processing device according to claim 19, wherein
the viewing environmental light information includes illumination information representing brightness of the viewing environment and/or luminance information representing display luminance of the display device; and
the image processing device includes an image capturing device and is configured to detect any one or a plurality of the illumination information and/or the luminance information and the viewer position information at a same time based on captured image data that is captured by the image capturing device.

23. The image processing device according to claim 19, wherein
the image processing device is used at a position spatially separated from the display device; and
the image processing device includes a connection distance detector configured to detect a distance between the display device and the image processing device and the viewing position detector is configured to detect a position of a viewer with respect to the display device by using the distance.

24. The image processing device according to claim 17, wherein the viewing environmental light information includes illumination information representing brightness of the viewing environment and/or luminance information representing display luminance of the display device.

25. The image processing device according to claim 17, wherein the viewing environmental light information includes information representing viewer pupil diameter estimated from illumination information representing brightness of the viewing environment and/or luminance information representing display luminance of the display device.

26. The image processing device according to claim 25, wherein the sense-of-depth parameter adjustment amount calculator is configured to calculate or estimate depth of field information which the display device should represent based on the information representing the viewer pupil diameter and to calculate the adjustment amount of the sense-of-depth parameter.

27. The image processing device according to claim 17, wherein the auxiliary data includes mask data that specifies an adjustment position of the sense-of-depth parameter corresponding to a position of the image data and/or a depth map corresponding to the position of the image data.

28. The image processing device according to claim 17, wherein the sense-of-depth parameter is an amount of blur.

29. The image processing device according to claim 17, wherein the sense-of-depth parameter is a binocular parallax amount.

30. An image processing method comprising:
an acquisition step in which a viewing environmental light information acquirer acquires viewing environmental light information that is information related to environmental light in a viewing environment of a display device; and
a calculation step in which a sense-of-depth parameter adjustment amount calculator calculates an adjustment amount of a sense-of-depth parameter of monocular cues and/or binocular cues used when the display device displays an image represented by image data based on the viewing environmental light information and auxiliary data to create a sense of depth of the image in the image data.

31. A non-transitory computer-readable recording medium storing an image processing program for causing a computer to perform:
an acquisition step of acquiring viewing environmental light information that is information related to environmental light in a viewing environment of a display device; and
a calculation step of calculating an adjustment amount of a sense-of-depth parameter of monocular cues and/or binocular cues used when the display device displays an image represented by image data based on the viewing environmental light information and auxiliary data to create a sense of depth of the image in the image data.
